(19) United States
(12) Patent Application Publication
(10) Pub. No.: US 2017/0339393 A1
(43) Pub. Date: Nov. 23, 2017

(54) METHOD FOR REGISTERING A PATIENT COORDINATE SYSTEM USING AN IMAGE DATA COORDINATE SYSTEM

(71) Applicant: Robert Bosch GmbH, Stuttgart (DE)

(72) Inventors: Dirk Staneker, Tübingen (DE); Philipp Troebner, Boeblingen (DE)

(21) Appl. No.: 15/581,711

(22) Filed: Apr. 28, 2017

(30) Foreign Application Priority Data
May 18, 2016 (DE) 102016208517.4

(51) Int. Cl. H04N 13/02; G06T 7/00

(52) U.S. Cl. CPC H04N 13/0203; G06T 2207/30088; G06T 7/0012; G06T 2207/10028

(57) ABSTRACT

A method for registering a patient using image data of a medical imaging device in a surgical navigation system, including the following: positioning a mobile scanning unit including a light source, in particular including a laser light source, in a first position, so that a light beam of the light source is directed onto a point of incidence on the skin surface of the patient, detecting the position of the scanning unit using a detection device in a detection device coordinate system, alternately deflecting the light beam with a micro-mirror and measuring a distance between the mobile scanning unit and the point of incidence, so that distances to different points of incidence are measured in succession, ascertaining a mapping between the detection device coordinate system and an image data coordinate system of the image data based on the measured distances and the detected position of the scanning unit.

### RELATED APPLICATION INFORMATION

The present application claims priority to and the benefit of German patent application no. 10 2016 208 517.4, which was filed in Germany on May 18, 2016, the disclosure of which is incorporated herein by reference.

### FIELD OF THE INVENTION

The present invention is directed to a method for registering a patient coordinate system of a patient using an image data coordinate system of a medical imaging device according to the descriptions herein and a surgical navigation system according to the descriptions herein.

Surgical navigation systems are often used in connection with surgical interventions. These make it possible for the position of surgical instruments to be inserted into image data during the intervention, the image data being ascertained using a medical imaging device. These image data may be, for example, image data from a computer tomograph or a magnetic resonance tomograph. In such navigation systems, it is necessary to adjust the actual position of the patient during the intervention using the image data, i.e., to register the patient using the image data of the medical imaging device.

In the related art, for example, methods are known in which markings are applied to the skin of the patient. The position of these markings in space may be detected with the aid of a suitable detection device, for example, a stereo camera. If the position of the detected markings in an image data coordinate system is known, a mapping of the coordinates of the patient in a detection device coordinate system may be calculated into the image data coordinate system.

Alternatively, it is possible to detect the position of the skin surface in the image data and, by comparing the position of the detected markers with the position of the skin surface in the image data, to infer a mapping of the coordinates of the detection device coordinate system into the image data coordinate system.

Furthermore, it is known to direct a light beam onto the skin of the patient with the aid of a mobile light source in order to generate a light point on the skin. The light point forms a temporarily visible marking whose position in space may be detected in the same way as a marking applied to the skin. The application of markings, for example by adhesive bonding, is not necessary in such a method. However, it has proven to be disadvantageous that it is necessary to generate and detect a substantial number of light points to obtain a sufficient quality of the registration. This makes the process relatively time-consuming.

### SUMMARY OF THE INVENTION

An object of the present invention is to make it possible to register a patient using image data of a medical imaging device in a surgical navigation system with increased accuracy and at increased speed.

The objective is achieved by a method for registering a patient using image data of a medical imaging device in a surgical navigation system, including the following method steps:
positioning a mobile scanning unit including a light source, in particular including a laser light source, in a first position, so that a light beam of the light source is directed onto a point of incidence on the patient's skin surface,
detecting the position of the scanning unit using a detection device in a detection device coordinate system,
alternately deflecting the light beam with the aid of a micro-mirror and measuring a distance between the mobile scanning unit and the point of incidence, so that distances to different points of incidence are measured in succession,
ascertaining a mapping between the detection device coordinate system and an image data coordinate system of the image data based on the measured distances and the detected position of the scanning unit.

The objective is further achieved by a surgical navigation system including a mobile scanning unit, which has a light source, in particular a laser light source, via which a light beam, in particular a laser beam, may be directed onto a point of incidence on a skin surface of the patient, including a micro-mirror for deflecting the light beam and a measuring unit for measuring a distance between the scanning unit and the point of incidence, a detection device for detecting the position of the scanning unit in a detection device coordinate system and a processing unit for ascertaining a mapping between the detection device coordinate system and an image data coordinate system of the image data based on the measured distances and the detected position of the scanning unit.

The mobile scanning unit may be moved freely in space and positioned at a first position, for example, by a user of the medical navigation system. Compared with the related art, the advantage results that a plurality of points may already be detected on the skin surface from this first position of the scanning unit. Detecting an increased number of points on the surface makes it possible to increase the accuracy of the registration. Moreover, the detection of the surface points may be carried out with a reduced expenditure of time by using a micro-mirror, since the user of the scanning device does not have to manually orient the scanning device to different points on the skin surface. A further advantage of the present invention is that the skin surface does not have to be located in a detection range of the detection device. It is sufficient if the scanning unit is located in the detection area. It is thus also possible to use parts of the skin surface for the registration, which are not directly detectable by the detection device, for example, because there is no direct line of sight between them and the detection device.

One advantageous embodiment of the present invention provides that the detection device is a camera, in particular a stereo camera. The markers of the scanning unit may be visually detected via the camera. The camera may be sensitive in the infrared range of the spectrum.

According to one embodiment, it is provided that markers situated on the scanning unit are detected for detecting the position of the scanning unit. The markers may be configured as IR markers which are detectable by a detector sensitive in the infrared range of the detection device. The markers may be situated in a predefined spatial position relative to one another. The spatial position of the markers may particularly be known, so that, based on the detected markers, the position of the markers in the detection device coordinate system and thus also the position of the scanning unit in the detection device coordinate system may be inferred.

One embodiment of advantageous configuration provides that the light beam is deflected along a linear trajectory. The linear deflection of the light beam may be made possible by pivoting the micro-mirror about a first pivot axis. Alternatively, the light beam may be deflected along a trajectory having a curvature or a curve. In such an embodiment, however, it is necessary for the micro-mirror to be pivotable about a first pivot axis and a second pivot axis positioned transversely to the first pivot axis.

It may be the case that if the distances are transferred to a processing unit via a wireless communication link, so that it is unnecessary to provide a wired communication link between the scanning unit and the processing unit. This makes it possible to improve the movability of the scanning unit in space. The distances may be measured with the aid of the light beam, in particular the laser beam. It may be in particular that a distance detection device is provided in the scanning unit, which ascertains the particular distance from the point of incidence on the skin surface before it is transferred to the processing unit.

According to one embodiment, a profile of a skin surface is ascertained in the image data. The image data may be configured, for example, as image data of an X-ray-based computer tomograph or a magnetic resonance tomograph. In the image data, for example, a contrast jump may be ascertained and, based on the contrast jump, the profile of the skin surface may be inferred. Alternatively or in addition, image data of a nuclear medical imaging method, e.g., SPECT, PET, or ultrasound image data may be used for determining the profile of the skin surface.

One advantageous embodiment provides that, for ascertaining the mapping between the detection device coordinate system and the image data coordinate system based on the measured distances between the scanning unit and the skin surface and based on the detected position of the scanning unit, a first point cloud of the detection device coordinate system is generated, which is registered using an additional point cloud of the image data coordinate system, in particular with the aid of an iterative closest point algorithm. A rule for mapping of coordinates of the detection device coordinate system into the image data coordinate system may be ascertained via the registration, so that coordinates of, for example, a surgical instrument ascertained in the detection device coordinate system, may be transformed into the image data coordinate system. Optionally, a reverse mapping from the image data coordinate system into the detection device coordinate system may also be ascertained.

The embodiment may be one in which reference markers are placed on the patient's skin surface, the position of the reference markers being detected using the detection device in the detection device coordinate system, the position of the reference markers being transformed into the image data coordinate system with the aid of the mapping, and the position of the reference markers in the image data coordinate system being compared with a reference position. The reference position of the reference markers in the image data coordinate system may, for example, be ascertained in advance with the aid of an examination in a medical imaging device. The comparison of the position of the reference markers calculated with the aid of the mapping with the reference position makes it possible to ascertain a measure for the quality of the mapping.

Alternatively, it is possible that, based on the measured distances and the ascertained mapping, an image of the skin surface is calculated in the image data coordinate system; this image is inserted into the image data and the position of the image of the skin surface is compared with the position of the skin surface in the image data. The comparison of the position of the skin surface calculated with the aid of the mapping with the position of the skin surface in the image data likewise makes it possible to ascertain a measure for the quality of the mapping.

A measure for the quality of the mapping between the detection device coordinate system and an image data coordinate system may be ascertained and, if the ascertained measure is lower than the predefined quality value, the mobile scanning unit is placed into a second position, in which a repeated detection of the position of the scanning unit and a repeated distance measurement is carried out. Such an iterative approach makes it possible to improve the quality of the mapping gradually until the predefined quality value is achieved.

### BRIEF DESCRIPTION OF THE DRAWINGS

FIG. 1 shows a schematic side view of elements of a surgical navigation system according to one exemplary specific embodiment of the present invention.

FIG. 2 shows a schematic top view of the surgical navigation system according to FIG. 1.

FIG. 3 shows a schematic representation of the sequence of a method according to one exemplary specific embodiment of the present invention.

### DETAILED DESCRIPTION

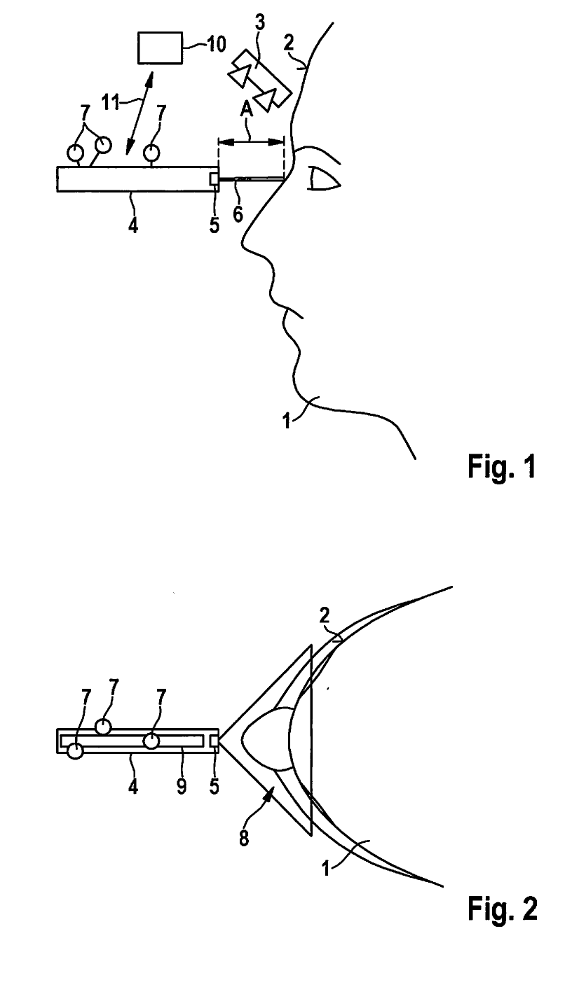

FIGS. 1 and 2 show such elements of a surgical navigation system which may be used to register a patient using three-dimensional image data. The image data may have been previously recorded with the aid of a medical imaging device, for example, a computer tomograph (CT) or a magnetic resonance tomograph (MRT). After registration is carried out, the position of surgical instruments may be inserted into the image data to assist an operator during a surgical intervention.

For the registration, the navigation system includes a mobile scanning unit 4, which is freely movable in space. Scanning unit 4 is configured in the manner of a laser scanner. Scanning unit 4 includes a light source 5, in particular a laser light source. A light beam 6, in particular a laser beam, may be directed to a point of incidence on a skin surface 2 of the patient via light source 5. Light beam 6 generated by light source 5 may have spectral components in the infrared range. In the beam path between the light source and the point of incidence, a micro-mirror for deflecting light beam 6 is further provided in the scanning unit. Light beam 6 may be deflected along a linear trajectory via the micro-mirror. It is thus possible for the light beam to scan a linear scanning area 8 without the need to change the position of scanning unit 4. Scanning unit 4 also includes a measuring unit for measuring a distance between scanning unit 4 and the point of incidence. The measuring unit may be, for example, part of an electronic unit 9 of scanning unit 4. The combination of measuring unit and micro-mirror makes automatic scanning of the skin surface in scanning area 8 possible.

The navigation system further includes a detection device 3 configured as a stereo camera for detecting the position of scanning unit 4 in a detection device coordinate system. Detection device 3 is sensitive in the infrared range. Markers 7 configured as infrared markers are situated on scanning unit 4 in a predefined position relative to one another. These markers 7 may be detected by detection device 3 for ascertaining the position of scanning unit 4 in space.

Furthermore, the navigation system includes a processing unit 10 for ascertaining a mapping between the detection device coordinate system and an image data coordinate system of the image data based on the measured distances and the detected position of scanning unit 4. Processing unit 10 is connected to scanning unit 4 via a wireless communication link 11, for example, a radio link. The distances ascertained by the measuring unit may be transmitted to processing unit 10 via this wireless communication link 11.

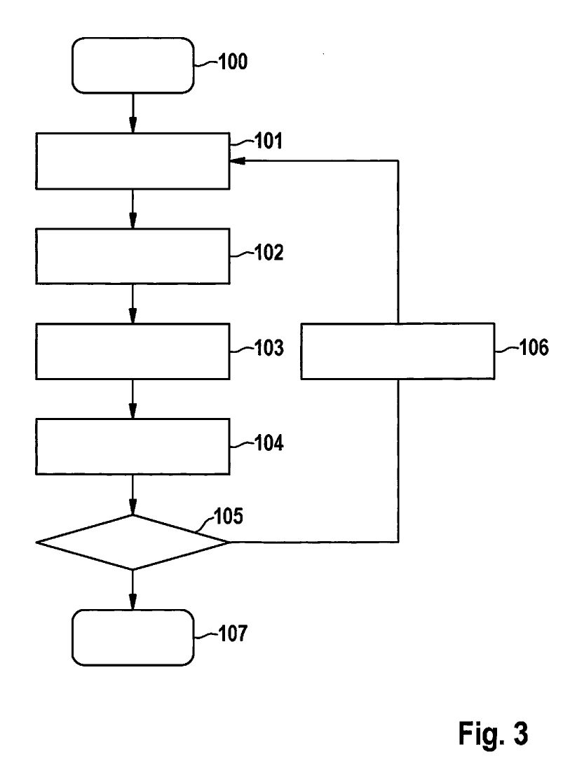

FIG. 3 schematically shows the sequence of a specific embodiment of the method according to the present invention for registering a patient using image data of a medical imaging device. The method may be, for example, carried out using the surgical navigation system described above.

Before start 100 of the actual registration, image data of the patient may be recorded using a medical imaging device. Particularly suitable are CT or MRT image data. From these image data, the profile of the skin surface may be extracted using methods known per se. This profile is determined by coordinates in an image data coordinate system.

To register patient 1 using the image data, mobile scanning unit 4 is positioned in a first position. The first position is selected in such a way that light beam 6 of light source 5 is directed onto a point of incidence on skin surface 2 of patient 1. Scanning unit 4 may be held manually in the first position by a user, for example, the operator. A holding device for supporting scanning unit 4 is not required. Scanning unit 4 is located in the first position within the detection range of detection device 3. In the case of detection device 3 configured as a stereo camera, this means that a direct line of sight between detection device 3 and scanning unit 4 is provided. In method step 101, detection device 3 detects the position of scanning unit 4 in the detection device coordinate system. In this case, markers 7 situated on scanning unit 4 are detected. The relative position of markers 7 relative to one another is known so that the orientation of scanning unit 4 in space may be calculated based on the detected position of individual markers 7.

In another method step 102, skin surface 2 is scanned with the aid of scanning unit 4. For scanning, light beam 6 is alternately deflected so that it is directed to a new point of incidence on skin surface 2, and the distance between scanning unit 4 and the skin surface is ascertained at this point of incidence. The distance is ascertained with the aid of light beam 6. The light beam reflected on the skin surface is detected by a measuring unit of the scanning device and the corresponding distance is calculated. For the determination of the distance, the following methods known per se may be used: transit time measurement of light pulses, measurement of the difference of the phase position of the emitted and the reflected light beam or triangulation.

Light beam 6 is deflected via the micro-mirror. The micro-mirror is pivoted about a pivot axis, so that the distances to skin surface 2 are detected along a linear trajectory—a line.

In following method step 103, the ascertained distances are transferred to processing unit 10 via wireless communication link 11.

In a subsequent method step 104, a first point cloud of the detection device coordinate system is generated based on the measured distances between scanning unit 4 and skin surface 2 and based on the detected position of scanning unit 4. The position of the scanned points of incidence on skin surface 2 is thus calculated in the detection device coordinate system. This corresponds to the profile of skin surface 2 of patient 1 in the treatment situation. Another point cloud of the image data coordinate system is generated from the image data. With the aid of an algorithm known per se for registering point clouds, for example, an iterative closest point algorithm, the two point clouds are registered and a mapping is ascertained between the detection device coordinate system and the image data coordinate system.

The registration is checked in method step 105. Initially, a measure for the quality of the mapping between the detection device coordinate system and an image data coordinate system is ascertained. In the case that the ascertained measure is greater than or equal to the predefined quality value, the registration is terminated, cf. method step 107. However, if the ascertained measure is below the predefined quality value, mobile scanning unit 4 is positioned in a second position in another method step 106. Subsequent to the change in the position of scanning unit 4, method steps 101, 102, 103, 104 and 105 are repeated. In the repeated pass, further coordinates of skin surface 2 are ascertained in the detection device coordinate system. Based on the coordinates ascertained in the first pass and/or in the second pass, a repeated registration is carried out in method step 104. This repeated registration provides an improved registration due to the greater quantity of coordinates in the detection device coordinate system, so that the result of the registration may be iteratively improved in this way.

In order to check the registration in method step 105, it is possible to place reference markers on skin surface 2 of patient 1, which are detected by the medical imaging device and whose reference position is therefore known in the image data coordinate system. The positions of these reference markers are detected by the detection device in the detection device coordinate system. The detected positions of the reference markers are then transformed into the image data coordinate system with the aid of the calculated mapping, and the position of the reference markers in the image data coordinate system is compared with the predefined reference position. The comparison may be carried out automatically and deliver a measure for the quality of the mapping between the detection device coordinate system and an image data coordinate system.

Alternatively or in addition, based on the measured distances and the ascertained mapping, it is possible to calculate an image of skin surface 2 in the image data coordinate system. This image of skin surface 2 may be inserted into the image data and the position of the image of skin surface 2 may be compared with the position of skin surface 2 in the image data. In this manner also, it is possible to provide a measure for the quality of the mapping between the detection device coordinate system and the image data coordinate system.

The above-described method and the surgical navigation system make the registration of a patient 1 using image data of a medical imaging device possible with increased precision and at increased speed. Furthermore, the measured distances may optionally be displayed in a display device of the surgical navigation system, for example, to monitor a tumor resection.

What is claimed is:

1. A method for registering a patient using image data of a medical imaging device in a surgical navigation system, the method comprising:
positioning a mobile scanning unit having a light source, in a first position, so that a light beam of the light source is directed onto a point of incidence on the skin surface of the patient;
detecting the position of the scanning unit using a detection device in a detection device coordinate system;
alternately deflecting the light beam with a micro-mirror and measuring a distance between the mobile scanning unit and a point of incidence, so that distances to different points of incidence are measured in succession; and
ascertaining a mapping between the detection device coordinate system and an image data coordinate system of the image data based on the measured distances and the detected position of the scanning unit.

2. The method of claim 1, wherein the detection device is a camera.

3. The method of claim 1, wherein markers situated on the scanning unit are detected for detecting the position of the scanning unit.

4. The method of claim 1, wherein the light beam is deflected along a linear trajectory.

5. The method of claim 1, wherein the distances are transferred via a wireless communication link to a processing unit.

6. The method of claim 1, wherein a profile of a skin surface is ascertained in the image data.

7. The method of claim 1, wherein, for ascertaining the mapping between the detection device coordinate system and the image data coordinate system based on the measured distances between the scanning unit and the skin surface and based on the detected position of the scanning unit, a first point cloud of the detection device coordinate system is generated, which is registered using an additional point cloud of the image data coordinate system.

8. The method of claim 7, wherein reference markers are placed on the skin surface of the patient, the position of the reference markers being detected using the detection device in the detection device coordinate system, the position of the reference markers being transformed into the image data coordinate system with the mapping, and the position of the reference markers in the image data coordinate system being compared with a reference position.

9. The method of claim 7, wherein, based on the measured distances and the ascertained mapping, an image of the skin surface is calculated in the image data coordinate system, and wherein the calculated image is inserted into the image data and the position of the image of the skin surface is compared with the position of the skin surface in the image data.

10. The method of claim 1, wherein a measure for the quality of the mapping between the detection device coordinate system and an image data coordinate system is ascertained and, if the ascertained measure is lower than the predefined quality value, the mobile scanning unit is placed into a second position, in which a repeated detection of the position of the scanning unit and a repeated distance measurement is carried out.

11. A surgical navigation system, comprising:
a mobile scanning unit, which includes a light source, via which a light beam is directable onto a point of incidence on the skin surface of the patient, including a micro-mirror for deflecting the light beam and a measuring unit for measuring a distance between the scanning unit and the point of incidence;
a detection device to detect the position of the scanning unit in a detection device coordinate system; and
a processing unit to ascertain a mapping between the detection device coordinate system and an image data coordinate system of the image data based on the measured distances and the detected position of the scanning unit.

12. The surgical navigation system of claim 11, wherein the light source includes a laser light source.

13. The method of claim 1, wherein the light source includes a laser light source.

14. The method of claim 1, wherein the detection device is a a stereo camera.

15. The method of claim 1, wherein, for ascertaining the mapping between the detection device coordinate system and the image data coordinate system based on the measured distances between the scanning unit and the skin surface and based on the detected position of the scanning unit, a first point cloud of the detection device coordinate system is generated, which is registered using an additional point cloud of the image data coordinate system, with an iterative closest point algorithm.
